(19) United States
(12) Patent Application Publication
(10) Pub. No.: US 2005/0011795 A1
(43) Pub. Date: Jan. 20, 2005

(54) Display page with pockets

(76) Inventor: Mark Vanderberg, Georgetown, TX (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/821,227

(22) Filed: Apr. 8, 2004

Related U.S. Application Data
(60) Provisional application No. 60/462,157, filed on Apr. 11, 2003.

(51) Int. Cl. B42D 3/04

(52) U.S. Cl. 206/472

(57) ABSTRACT

A display page with pockets includes a semi-rigid to rigid page and at least one pocket attached to the page. The pocket is deep enough to hold a plurality of photographs and includes an at least partially transparent front wall connected to at least one side wall, a window disposed adjacent an opening of the pocket on the front wall, and a flap disposed proximate the opening of the pocket that is moveable between an open position and a closed position covering the opening.

### RELATED APPLICATION DATA

The present application is a non-provisional application based on, and claiming the priority benefit of, co-pending U.S. Provisional Application Ser. No. 60/462,157, which was filed on Apr. 11, 2003, and is expressly incorporated by reference herein.

### TECHNICAL FIELD OF THE DISCLOSURE

The present disclosure relates generally to a book or album for displaying items such as photographs and, more particularly, to a display page in such a book or album including a plurality of pockets for additional storage space.

### BACKGROUND OF THE DISCLOSURE

Album pages for displaying photographs are generally known in the art. Album pages with picture pockets are also known in the art. For example, U.S. Pat. No. 5,316,404 discloses a storage page for holding stacked groups of photographic prints, such that the topmost print in the stack is visible. An album containing such pages is also disclosed. The storage page includes a rigid page backing, and a plurality of expandable flexible pockets mounted thereon. Each of the pockets has a transparent front wall and side and bottom walls of sufficient width to accommodate 10 to 40 photographic prints.

### SUMMARY OF THE DISCLOSURE

In accordance with one aspect of the disclosure, a display page having at least one pocket for accepting a plurality of photographs is disclosed. The display page includes the at least one pocket that is attached to a semi-rigid to rigid page. The pocket is deep enough to hold a plurality of photographs and includes an at least partially transparent front wall connected to at least one side wall, a window disposed adjacent an opening of the pocket on the front wall, and a flap disposed proximate the opening of the pocket, that is moveable between an open position and a closed position covering the opening.

In accordance with another aspect of the disclosure, a display page having pockets is disclosed. The display page includes a semi-rigid to rigid page and the at least one pocket. The at least one pocket is attached to the page by at least one flange extending from at least one side wall of the pocket. The pocket is adapted to hold media storage items and includes an at least partially transparent front wall connected to the at least one side wall, a window disposed adjacent an opening of the pocket on the front wall, and a flap disposed proximate the opening of the pocket, that is moveable between an open position and a closed position covering the opening.

In accordance with another aspect of the disclosure, a display page having pockets is disclosed. The display page includes a semi-rigid to rigid page having a first and a second side, a first pocket, and a second pocket. The first pocket is attached to the first side of the page and is deep enough to hold a plurality of photographs. The first pocket includes an at least partially transparent front wall connected to at least one side wall, and a window disposed near an opening of the pocket on the front wall. The opening and window are covered by a flap disposed proximate the opening of the pocket, that is moveable between an open position and a closed position. The second pocket is attached to the second side of the page and is deep enough to hold at least one media storage device. The second pocket includes an opening that is covered by a flap that is moveable between an open position and a closed position.

### BRIEF DESCRIPTION OF THE DRAWINGS

FIG. 1 is a front view of one embodiment of a display page having pockets, both pockets being in a closed position;

FIG. 2 is an isometric view of the display page of FIG. 1, with one pocket being in an open position;

FIG. 3 is a front view of an alternate embodiment of a display page having pockets, both pockets being in a closed position;

FIG. 4 is an isometric view of the display page of FIG. 3, with one pocket being in an open position;

FIG. 5 is a front view of another alternate embodiment of a display page having pockets, both pockets being in a closed position;

FIG. 6 is an isometric view of the display page of FIG. 5, with one pocket being in an open position;

FIG. 7 is a rear view of one embodiment of a display page having pockets, both pockets being in a closed position;

FIG. 8 is a side view of the page and pockets of FIG. 7, with both pockets being in an open position;

FIG. 9 is a rear view of another embodiment of a display page having a pocket, the pocket being in a closed position; and

FIG. 10 is a side view of the page and pocket of FIG. 9, with the pocket being in an open position.

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but, on the contrary, the intention is to cover all modifications, alternative constructions, and equivalents falling within the spirit and scope of the disclosure.

### DETAILED DESCRIPTION

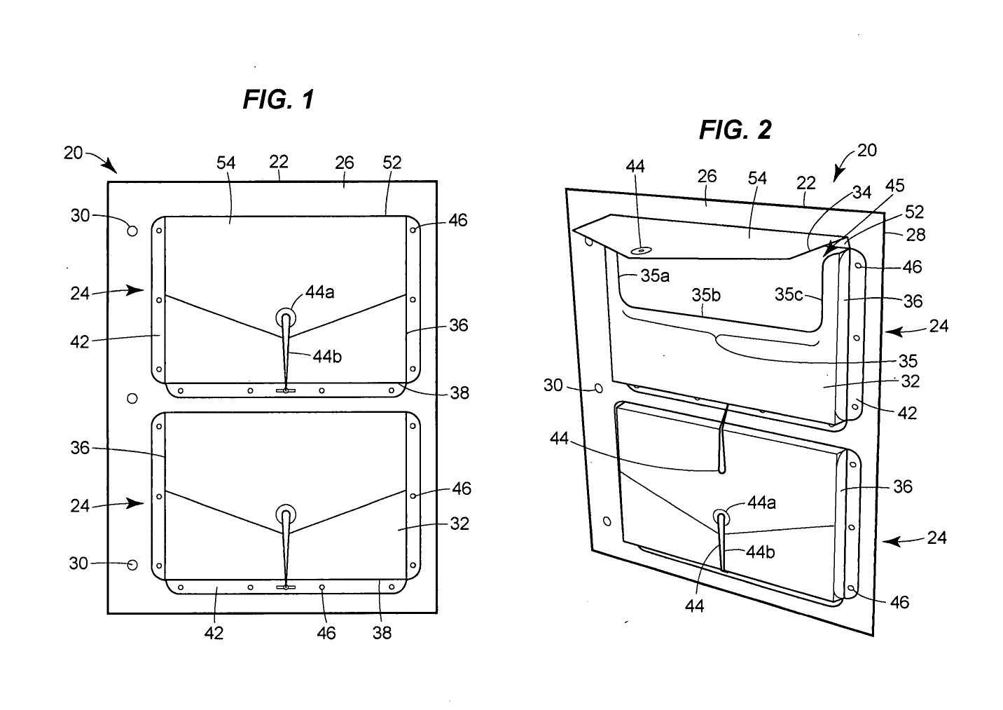

Referring now to the drawings, and with specific reference to FIG. 1, a display page with pockets constructed in accordance with the teachings of the disclosure is generally depicted by reference numeral 20. As shown therein, the display page 20 includes a rigid to semi-rigid page 22 and a pair of pockets 24. It is, however, contemplated that the display page 20 may include one or more pockets 24, wherein each of the pockets 24 may be have a variety of sizes, shapes, and features.

In one exemplary embodiment, as illustrated in FIGS. 1 and 2, the page 22 includes a front side 26, a back side 28, and a plurality of apertures 30 for attachment of the page 22 to a ring binder/photo album (not shown).

The pockets 24, in this embodiment, include a front wall 32, a rear wall 34, a pair of side walls 36, a bottom wall 38, a flap 40, flanges 42, a closing mechanism 44, and an opening 45. The front wall 32 and the rear wall 34 are substantially parallel and may be sized to hold various objects, such as photographs of different standard and non-standard sizes. The front wall 32 includes a notched out portion or window 35 located near a top and center of the front wall 32. The window may be defined by edges 35a, 35b, 35c, and the opening 45. As seen in FIG. 2, the window 35 is sized to take-up approximately half of the front wall 32, but may be sized to take-up more or less front wall 32 space than is depicted in FIG. 2. As such, the window 35 may be disposed on a majority or a minority of the front wall 32. For example, the window 35 may only be a slight window 35 located near the top of the front wall 32, as seen in FIG. 6, to provide easier and/or better access to the objects in the pockets 24, such as for insertion and removal of photographs (not shown). The window 35 may, however, be a large window 35, as seen in FIG. 4, to provide a substantially unobstructed view of the objects in the pockets 24 and may provide ample clearance for insertion and removal of photographs or objects.

The front and rear walls 32, 34 are connected at the bottom by the bottom wall 38 and at the opposed sides by the pair of side walls 36. The depth of the pockets 24 will be determined by the width of the pair of side walls 36 and the bottom wall 38, which are all substantially similar in width in this example. The rear wall 34 may be part of the page 22, or may be a separate piece integral to the pocket 24.

The flap 40, in this embodiment, includes a top portion 52 and front portion 54. The top portion 52 of the flap 40 extends outwardly from the top of the rear wall 34, and is similar in shape and size to the bottom wall 38. The width of the top portion 52 determines, in part, the depth of the pocket 24, and the top portion 52 closes the top or opening 45 of the pocket 24. The front portion 54 of the flap 40 extends outwardly from the top portion 52, and is located and oriented such that the front portion 54 abuts and lays substantially parallel to the front wall 32, when the pocket is in a closed position, as seen in FIG. 1. The front portion 54 is sized to at least cover the window 35 of the front wall 32 and retain items disposed in the pocket 24, when the pocket 24 is in a closed position and, as such, may vary greatly in size and shape. For example, as seen in FIG. 4, the front portion 54 is large enough to cover a relatively large window 35, whereas the front portion 54, as seen in FIG. 6, is much smaller to cover a relatively small window 35.

The flanges 42 in this exemplary embodiment are located at the intersections of the rear wall 34 with the side walls 36 and the bottom wall 38. The flanges 42 are oriented parallel to the rear wall 34 and extend outwardly therefrom. Fasteners 46, such as rivets 46, penetrate the flanges 42 and attach the pockets 24 to the front side 26 of the display page 20. However, the flanges 42 can be attached, fastened, or adhered to the page 22 in any suitable fashion.

A first portion 44a of the closing mechanism 44 is located near and attached to the center and bottom of the front portion 54, and is in this embodiment a knob or button adapted to receive a second portion 44b of the closing mechanism 44. The second portion 44b of the closing mechanism 44 is located near and attached to the flange 42 extending from the bottom wall 38. In this embodiment, the second portion 44b of the closing mechanism 44 is a bungee cord that, when stretched, reaches and connects to the first closing portion, and when released, pulls the first portion 54 against the front wall 32, thereby closing the pocket 24.

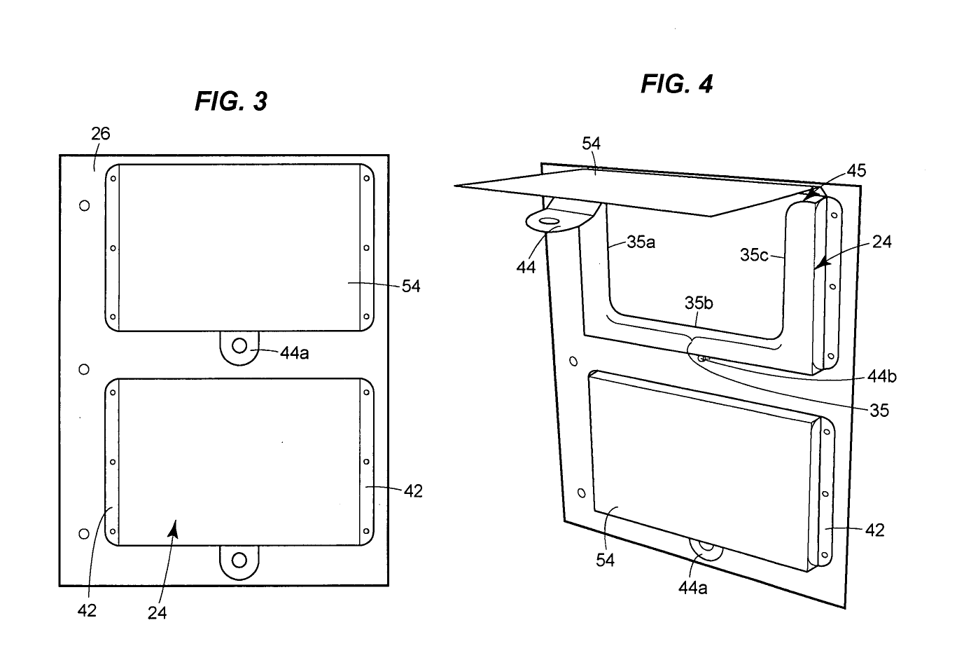

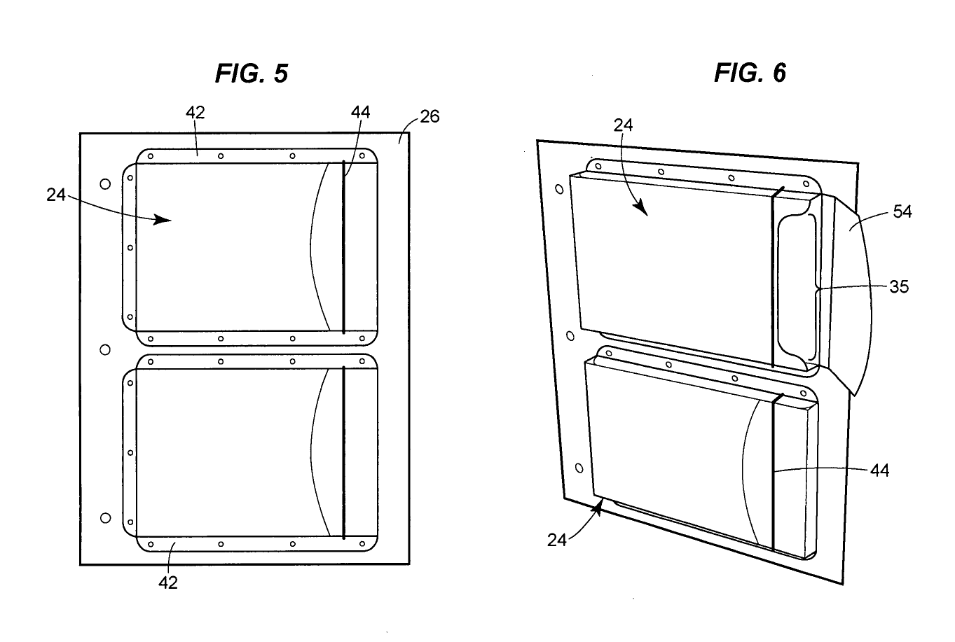

The display page 20 is not limited to the embodiment described above, but may have additional, fewer or varying features to those already described. For example, in an alternate embodiment as seen in FIGS. 3 and 4, the pockets 24 may only have two flanges 42, or may have no flanges 42 at all. Similarly, the closing mechanism 44 may vary and include other type of closing mechanisms 44. For example, as seen in FIGS. 3 and 4, the first portion 44a of the closing mechanism 44 may be a tab having an aperture, and the second portion 44b of the closing mechanism 44 may be a button or knob onto which the first portion 44a snaps. As seen in FIGS. 5 and 6, the closing mechanism 44 may only have a single portion, such as a bungee cord that attaches near both the sidewalls 36 and holds down the top portion 54 when the pocket 24 is in the closed position with the top portion 54 of the flap 40 inserted between the bungee cord and the front wall 32, as seen in FIG. 5. The closing mechanism 44, may also include, but is not limited to, Velcro®, hook-and-loop fasteners, adhesives, clips, etc. Similarly, the fasteners 46 need not be limited to rivets, but may include other types of fasteners 46. For example, the fasteners 46 may include, but are not limited to, tape, staples, Velcro®, adhesive, and the like.

The materials and attributes of the page 22 and pockets 24 may also vary. For example, the page 22 and pockets 24 may be constructed from a variety of materials, including, but not limited to, wood, paper, plastic, metal, etc. As such, the page 22 and/or the pockets 24 may be constructed from a soft, semi-rigid, or rigid material. Similarly, one or more of the walls or the flap 40 of the pockets 24 or display page 20 may be clear, transparent, and/or opaque.

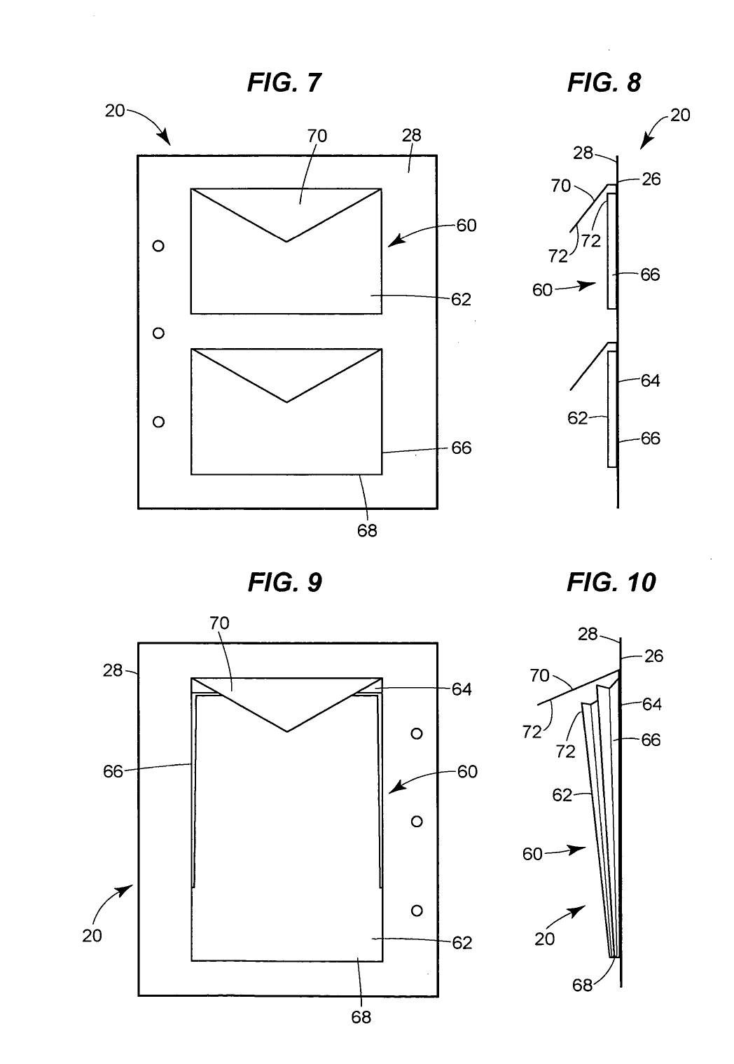

In another exemplary embodiment, as illustrated in FIGS. 7-10, the back side 28 of the display page 20 may include one or more pockets 60. The pockets 60 may be identical to, or similar to, the pockets 24. In this embodiment, however, the pockets 60 include a front wall 62, a rear wall 64, a pair of side walls 66, a bottom wall 68, a flap 70 and a closing mechanism 72.

The front wall 62 and the rear wall 64 are substantially parallel and may be sized to hold various objects, such as photo negatives, CD's, disks, or other items that may be associated with photography and/or photographs. Being that the pockets 24 may be designed to hold a large amount of objects, such as 24-36 photographs for example, and the pockets 60 may be designed to hold photo negatives and the like, the depth of the pockets 60 may be slightly less to substantially less than the depth of the pockets 24. In other examples, the pockets 60 can be of the same depth or of a greater depth that the pockets 24, as needed. The front and rear walls 62, 64 are connected by the bottom wall 68 and by the pair of side walls 66. The depth of the pockets 60 will be determined by the width of the pair of side walls 66 and the bottom wall 68. The sidewalls 66 and the bottom wall 68 in this embodiment are expandable. For example, as seen in FIG. 10, the sidewalls 66 and the bottom wall 68 may be pleated to allow for the expansion of the sidewalls 66 and the bottom wall 68. Alternatively, the pockets 24 may be fabricated from elastic material to allow for the expansion. As seen in FIG. 8, however, the pockets 60 need not be expandable.

The flap 70 in this embodiment extends outwardly from the top of the rear wall 64 (FIGS. 8 and 10). The closing mechanism 72 is an adhesive located on either or both of the flap 70 and the front wall 62, which when abutted close the pocket 60. The pockets 60, like the pockets 24, are not limited to the embodiment described above, but may have additional, fewer or varying features to those already described. For example, the closing mechanism 72 may vary and include other type of closing mechanisms 72. For example, the closing mechanism 72 may have one or more portions, and may include such fasteners as Velcro®, hook-and-loop fasteners, clips, etc.

The materials and attributes of the pockets 60 may also vary. For example, the pockets 60 may be constructed from a variety of materials, including, but not limited to, wood, paper, plastic, metal, etc. As such, the pockets 60 may be constructed from a soft, semi-rigid, or rigid material. Similarly, one or more of the walls and the flap 70 of the pockets 60 may be clear, transparent, or opaque.

The foregoing detailed description has been given for clearness of understanding only. No unnecessary limitations should be understood therefrom, as modifications will be obvious to those skilled in the art.

1. A display page having pockets fro accepting a plurality of photographs, comprising:
a semi-rigid to rigid page; and
at least one pocket attached to the page, the pocket being deep enough to hold the plurality of photographs and including an at least partially transparent front wall connected to at least one side wall and a window disposed adjacent an opening of the pocket on the front wall, and a flap disposed proximate the opening of the pocket and being moveable between an open position and a closed position covering the opening.

2. The display page of claim 1, wherein the flap covers the window.

3. The display page of claim 1, wherein the pocket is attached to the page by at least one flange extending from the at least one side wall.

4. The display page of claim 1, further including a locking mechanism adapted to retain the flap in the closed position.

5. The display page of claim 4, wherein at least one of a first and a second portion of the locking mechanism is disposed on the flap.

6. The display page of claim 1, wherein the window is disposed over a majority of the front wall of the pocket.

7. The display page of claim 1, wherein the window is disposed over a minority of the front wall of the pocket.

8. The display page of claim 1, wherein the opening of the pocket is disposed proximate a side edge of the display page.

9. The display page of claim 1, wherein the opening of the pocket is disposed proximate a top edge of the display page.

10. The display page of claim 1, further including at least a second pocket on a side of the page opposite the side to which the at least one pocket is attached.

11. A display page having pockets, comprising:
a semi-rigid to rigid page; and
at least one pocket attached to the page by at least one flange extending from at least one side wall of the pocket, wherein the pocket is adapted to hold media storage items and includes an at least partially transparent front wall connected to the at least one side wall, a window disposed adjacent an opening of the pocket on the front wall, and a flap disposed proximate the opening of the pocket and being moveable between an open position and a closed position covering the opening.

12. The display page of claim 11, wherein the flap covers the window.

13. The display page of claim 11, further including a locking mechanism adapted to retain the flap in the closed position.

14. The display page of claim 13, wherein at least one of a first and a second portion of the locking mechanism is disposed on the flap.

15. The display page of claim 11, wherein the window is disposed over a majority of the front wall of the pocket.

16. The display page of claim 11, wherein the window is disposed over a minority of the front wall of the pocket.

17. The display page of claim 11, wherein the opening of the pocket is disposed proximate a side edge of the display page.

18. The display page of claim 11, wherein the opening of the pocket is disposed proximate a top edge of the display page.

19. The display page of claim 11, further including at least a second pocket on a side of the page opposite the side to which the at least one pocket is attached.

20. A display page having pockets, comprising:
a semi-rigid to rigid page having a first side and a second side;
a first pocket attached to the first side of the page, the first pocket being deep enough to hold a plurality of photographs and including an at least partially transparent front wall connected to at least one side wall, and a window disposed near an opening of the pocket on the front wall, the opening and window being covered by a flap disposed proximate the opening of the pocket, the flap being moveable between an open position and a closed position; and
a second pocket attached to the second side of the page, the second pocket being deep enough to hold at least one media storage device, the second pocket includes an opening that is covered by a flap that is moveable between an open position and a closed position.

21. The display page of claim 20, wherein the at least one media storage device are negatives of the photographs.

22. The display page of claim 20, wherein the at least one media storage device is one or more compact disks.
